(19) United States
(12) Patent Application Publication
(10) Pub. No.: US 2014/0347571 A1
(43) Pub. Date: Nov. 27, 2014

(54) LOW PROFILE BACKLIGHT APPARATUS FOR HIGH-BRIGHTNESS MICRODISPLAYS

(71) Applicant: Raytheon Company, Waltham, MA (US)

(72) Inventor: John Jackson, Sachse, TX (US)

(73) Assignee: RAYTHEON COMPANY, Waltham, MA (US)

(21) Appl. No.: 13/901,726

(22) Filed: May 24, 2013

(51) Int. Cl. G02B 27/01; F21V 8/00

(52) U.S. Cl. CPC G02B 27/0189; G02B 6/0033; G02B 6/0043; G02B 6/0053; G02B 6/0051; G02B 6/0073; G02B 6/0068
USPC 349/11; 362/609; 362/602

(57) ABSTRACT

An edge-lit waveguide-based backlighting apparatus for high-brightness microdisplays. In one example, the backlighting apparatus includes a waveguide having substantially parallel top and bottom surfaces and a side surface substantially perpendicular to the top and bottom surfaces and extending between the top and bottom surfaces along a periphery of the waveguide, a specularly reflective film disposed on and at least partially covering the bottom and side surfaces of the waveguide, and at least one light source disposed on the side surface and configured to emit light into the waveguide in a direction of a length of the waveguide, the waveguide being configured to direct the light out of an output region of the top surface of the waveguide.

### BACKGROUND

Microdisplays, such as liquid crystal display (LCD) microdisplays are used in many target location or scene viewing devices (such as rifle scopes, laser rangefinders, or other apparatus) to display a variety of information to a user. Numerous of these devices provide a so-called direct-view optical path, while simultaneously allowing the user to view processed imagery (for example, processed infrared imagery) and/or information overlays (such as a reticle, or environmental or positional information) on the microdisplay.

Backlights may be used to illuminate LCD microdisplays used in a variety of applications, including, for example, cellular telephones, tablets, and laptop computers. One type of backlight uses a light source, such as a light-emitting diode (LED), which is coupled to a waveguide into which light is injected. The light source is typically mounted at an outer peripheral edge of the waveguide and is energized to emit light into the waveguide. The light undergoes several reflections between the surfaces of the waveguide until being transmitted through a top surface to illuminate the display. Because space is a premium in many backlight applications involving microdisplays, conventional waveguide-based backlights use very thin waveguides and low-profile LEDs. As low-profile LEDs typically have limited light output, these microdisplays have relatively low brightness. Such presently-available LCD microdisplays are not bright enough to use in combination with a direct-view optical path when viewing scenes in full daylight.

One approach to providing a high-brightness backlight employs a collimating lens. However, this approach has several drawbacks, including relatively large size, and low-etendue. Accordingly, the illumination does not fill the pupil of common day-sight optics, and therefore the viewing of the display becomes very narrow such that the user rapidly loses the image of the display when moving the eye within the eyebox.

### SUMMARY OF INVENTION

Aspects and embodiments are directed to lighting apparatus and methods that provide high-brightness illumination while avoiding the drawbacks of large size and low etendue associated with conventional high-brightness backlights.

According to one embodiment, an edge-lit waveguide backlight apparatus comprises a waveguide having substantially parallel top and bottom surfaces and a side surface substantially perpendicular to the top and bottom surfaces and extending between the top and bottom surfaces along a periphery of the waveguide, a specularly reflective film disposed on and at least partially covering the bottom and side surfaces of the waveguide, and at least one light source disposed on the side surface and configured to emit light into the waveguide in a direction of a length of the waveguide, the waveguide being configured to direct the light out of an output region of the top surface of the waveguide.

In one example the waveguide comprises a solid transparent material. The backlight apparatus may further comprise a microdot array disposed on the output region of the top surface of the waveguide. In one example the microdot array includes a plurality of microdots arranged in a two-dimensional array, wherein the spacing between the microdots has a linear gradient along the length of the waveguide. The backlight apparatus may further comprise an angular spectrum restrictor disposed approximately parallel to the top surface of the waveguide and positioned to restrict output illumination through the output region to a predetermined range of angles. In one example the angular spectrum restrictor includes a first prismatic angular control film. In another example the angular spectrum restrictor further includes a second prismatic angular control film oriented orthogonally to the first prismatic angular control film. The backlight apparatus may further comprise a diffuser disposed on the output region of the top surface of the waveguide and positioned between the top surface of the waveguide and the angular spectrum restrictor. In one example the specularly reflective film is further disposed on a portion of the top surface of the waveguide excluding the output region. In another example the specularly reflective film is a non-metallic polymer film. In another example the at least one light source includes at least one light emitting diode. In another example the at least one light emitting diode includes three light emitting diodes of different illumination colors.

According to another embodiment, a scene viewing apparatus comprises an eyepiece, direct view optics configured to receive light from a viewed scene and focus the light along a direct view optical path to the eyepiece, a microdisplay, an edge-lit waveguide backlighting apparatus optically coupled to the microdisplay and configured to illuminate the microdisplay; and a beamsplitter configured to couple illumination from the microdisplay into the direct view optical path to the eyepiece. The edge-lit waveguide backlighting apparatus includes a waveguide having substantially parallel top and bottom surfaces and a side surface substantially perpendicular to the top and bottom surfaces and extending between the top and bottom surfaces along a periphery of the waveguide, a specularly reflective film disposed on and at least partially covering the bottom and side surfaces of the waveguide, and at least one light emitting diode disposed on the side surface and configured to emit light into the waveguide in a direction of a length of the waveguide, the waveguide being configured to direct the light out of an output region of the top surface of the waveguide.

In one example the microdisplay is a liquid crystal display panel. The edge-lit waveguide backlighting apparatus may further include a microdot array disposed on the output region of the top surface of the waveguide. The edge-lit waveguide backlighting apparatus may further include a pair of prismatic angular control films disposed approximately parallel to the top surface of the waveguide and positioned to restrict output illumination through the output region to a predetermined range of angles, the pair of prismatic angular control films including a first film and a second film oriented orthogonally to the first film. The edge-lit waveguide backlighting apparatus may further include a diffuser disposed on the output region of the top surface of the waveguide and positioned between the top surface of the waveguide and the pair of prismatic angular control films. In one example the specularly reflective film is further disposed on a portion of the top surface of the waveguide excluding the output region. In another example the at least one light emitting diode includes three light emitting diodes of different illumination colors. In another example the waveguide comprises a solid transparent material.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a diagram of one example of a viewing apparatus according to aspects of the invention;

FIG. 2A is a side view of one example of an edge-lit waveguide backlight according to aspects of the invention;

FIG. 2B is a top view of the edge-lit waveguide backlight of FIG. 2A; and

FIG. 3 is a diagram showing a side view of one example of an edge-lit waveguide backlight apparatus according to aspects of the invention.

### DETAILED DESCRIPTION

As discussed above, it is desirable in some instances to provide a viewing apparatus, such as a rifle scope, laser rangefinder, or other scene viewing device, that is capable of providing a direct view optical path in combination with overlaid information from a microdisplay even in conditions of full daylight. However, conventional edge-lit waveguide based backlights for LCD microdisplays are not bright enough for such full daylight viewing, and high-brightness backlights suffer from other drawbacks. Accordingly, aspects and embodiments are directed to a high-brightness backlighting apparatus including a waveguide design that allows the use of larger light sources which may be several orders of magnitude brighter than the LEDs used in conventional edge-lit waveguide based backlights. Contrary to conventional practice, in which the waveguides are typically made a thin as possible to achieve uniform illumination, embodiments disclosed herein use a thick waveguide that can accommodate larger, more powerful, high-brightness illumination sources, such as high-brightness LEDs, for example. Generally it would be expected that thick waveguides cannot be used in such backlighting applications because for much of the illumination, the condition of total internal reflection, generally required for proper functioning of the waveguide, is not met, and because thicker waveguides tend to suffer from “hot-spotting” from the LEDs. However, the present inventor has surprisingly discovered that a thick waveguide can be used, with various configurations and aspects as discussed in more detail below. In addition, aspects and embodiments provide for multiple illumination sources of different colors to be used with the same waveguide to achieve color display, as discussed further below.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

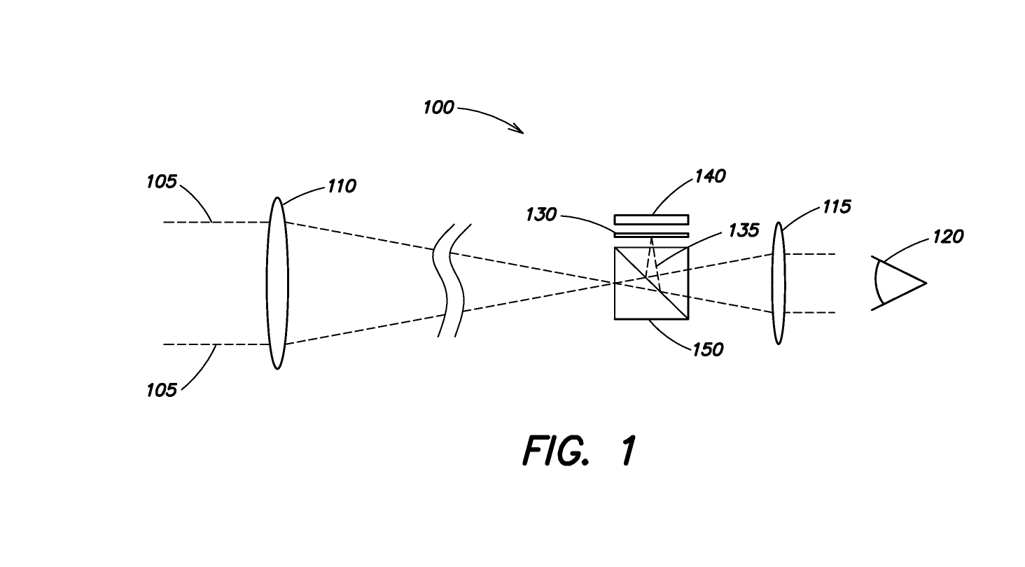

Referring to FIG. 1, there is illustrated an example of a viewing apparatus 100, such as a rifle scope or other scene viewing and/or target location device, that includes both a direct view optical path and a microdisplay. Incident light 105 from a viewed scene is directed and focused via direct view optics 110 and an eyepiece 115 to the eye 120 of a user. Although the direct view optics 110 and eyepiece 115 are schematically represented in FIG. 1 by lens elements, either component may include one or more refractive and/or reflective optical elements, as will be appreciated by those skilled in the art. The viewing apparatus 100 includes a microdisplay 130 and a backlight apparatus 140 configured to illuminate the microdisplay. According to one embodiment, the backlight apparatus includes an edge-lit waveguide and one or more illumination sources as discussed further below. A beamsplitter 150 is configured to couple light 135 from the microdisplay 130 into the optical path to be directed via the eyepiece 115 to the eye 120, thereby allowing the user to view the light from the microdisplay overlaid on the scene viewed via the direct view optical path.

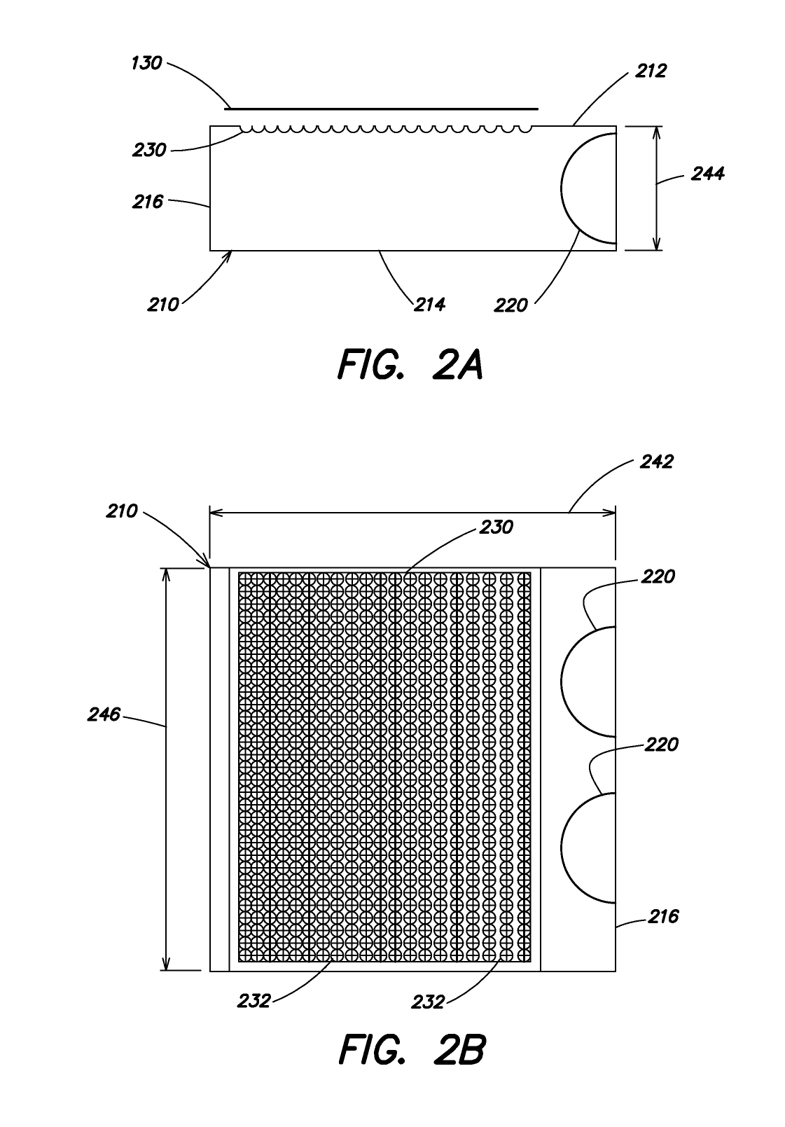

FIGS. 2A and 2B illustrated side and top views, respectively, of one example of a backlight apparatus 140 according to certain embodiments. The backlight apparatus 140 includes a waveguide 210 and one or more illumination (light) sources 220. The waveguide 210 includes a top surface 212 and an opposed bottom surface 214, which are substantially parallel to each other. A side or edge surface 216 extends between the top and bottom surfaces 212, 214 along the periphery of the waveguide 210. According to one embodiment, the waveguide 210 comprises a solid transparent material whose exterior sides are inwardly reflective, as discussed further below. A used herein the term “transparent” refers to a material that is substantially optically transmissive (transmits a majority, but not necessarily all) to light in a wavelength range of interest, for example, to visible light. The waveguide may or may not be contained by an external housing (not shown). In one embodiment, a microdot array 230 is disposed over a portion of the top surface 212, or bottom surface 214, or both top and bottom surfaces, and configured to scatter light emitted from the light source(s) 220, as discussed in more detail below. The microdisplay 130 is positioned approximately parallel to the top surface 212 and receives light coupled out of a portion of the top surface 212 (referred to as the output illumination region), as discussed further below.

According to certain examples, the waveguide 210 has dimensions such that the size of the top surface 212 (length and width) is similar to the size of the microdisplay 130. The waveguide 210 may have an aspect ratio between its length 242 and thickness 244 of at least approximately 2.5, or an aspect ratio between its width 246 and thickness 244 of at least approximately 2.5. In one example, the waveguide 210 has a length 242 and width 246 of approximately 13 millimeters (mm) each, and a thickness 244 in the range of approximately 3-4 mm. In another example, a ratio between the surface area of the output illumination region and the combined surface area of the internal surfaces 212, 214, 216 of the waveguide may be in a range of approximately 0.2 to 0.3. In another example, the ratio between the edge-to-edge dimension of the output illumination region, referred to herein as the bisector dimension (this bisector dimension extending along a line formed by the juncture of the plane of the top surface 212 and a plane normal to the plane of the top surface and bisecting the output illumination region), and the thickness 244 of the waveguide is in a range of approximately 0.1 to 0.3.

According to one embodiment, the light source 220 is a solid state, point source of light, such as an LED. The light source 220 may be mounted at the edge surface 216 of the waveguide 210. In some examples, the light source 220 is mounted on a carrier or circuit board (not shown) which is attached to the waveguide 210. As discussed above, according to certain embodiments, the light source 220 is a high brightness, high power LED, for example, having an illumination intensity of approximately 100 lumens at 1 Watt input power. The LED should have a diameter that is less than the thickness 244 of the waveguide 210.

According to one embodiment, the waveguide 210 may be sized and configured to accommodate multiple light sources 220, for example, 1-3 LED light sources. Since the LEDs may be different colors, a color display may be achieved even without the use of color filters on the microdisplay 130. Using 3 LED light sources, for example, red, green, and blue, allows for a color microdisplay to be provided. In other examples, where the microdisplay may include color filters, a single high-brightness white LED may be used. Additionally, a monochrome display may be provided using only a single LED.

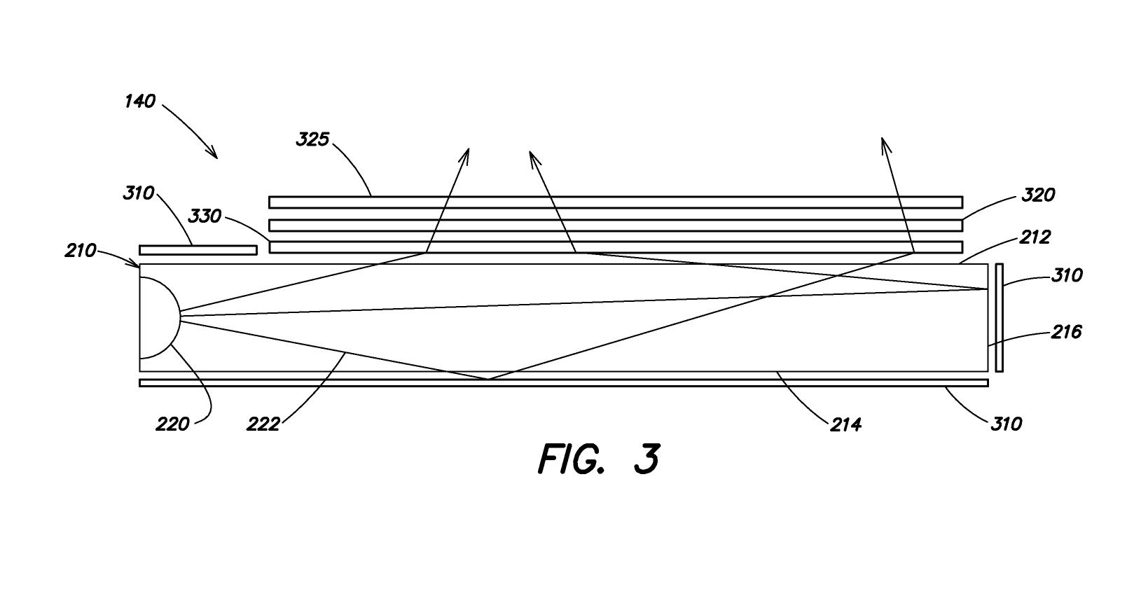

FIG. 3 is a schematic diagram illustrating one example of an edge-lit waveguide backlight apparatus 140 according to certain embodiments. As shown in FIG. 3, light 222 emitted from the light source(s) 220 travels along the waveguide, reflects off the waveguide surfaces 212, 214, 216, and is coupled out of the top surface 212 and directed towards the microdisplay 130. Conventionally, thin edge-lit waveguides are mounted in a diffusely reflective housing which is made of a white plastic such as acrylic, polycarbonate, or silicone. Light emitted from the light source associated with such conventional thin waveguides is totally internally reflected until it is incident on the (uncoated) top surface at an angle of incidence less than a critical angle, and transmitted though the top surface. As discussed above, for thick waveguides 210 according to certain embodiments, much of the illumination from the light source 220 fails total internal reflection, which would lead one to expect that the waveguide would not provide uniform illumination of the microdisplay 130. To address this issue, the surfaces of the waveguide are configured to be highly reflective or “mirrored.” In particular, the surfaces 212, 214, and 216 of the waveguide 210 (except for the portion of the surface 210 that is beneath the microdisplay 130 and through which it is desired to transmit the illumination) are configured to be specularly reflective at the wavelengths of the light emitted by the light source(s) 220, rather than diffusely reflective. In certain examples, a specularly reflective film 310 is disposed on the surfaces of the waveguide 210, as shown in FIG. 3. In one example, the specularly reflective film is a non-metallic polymer film. Since the surfaces of the waveguide 210 are highly reflective, the light emitted by the light source(s) 220 is reflected inside the waveguide until it is coupled out of the portion of the top surface 212.

As discussed above, according to one embodiment, a microdot array 230 is disposed on a portion of the top surface 212 of the waveguide 210, as shown in FIGS. 2A and 2B. The microdot array 230 includes a plurality of microdots 232, which may be arranged in a periodic or semi-periodic pattern. The microdot array 230 is configured to “roughen” the top and/or bottom surfaces 212, 214 of the waveguide and scatter the light incident thereon, so as to “randomize” reflection of the light inside the waveguide, contributing to a more uniform distribution of the light and therefore more uniform illumination of the microdisplay 130. In the example illustrated in FIGS. 2A and 2B, the microdots 232 are arranged in a two-dimensional array, and the spacing between the microdots has a linear gradient over the length 242 of the waveguide 210, with the microdots being spaced further apart near the light source 220 and closer together at the far end of the waveguide. However, this arrangement is one example only, and the microdots 232 may be arranged in any two dimensional pattern over the desired portion of the top surface 212 of the waveguide 210. The size of the microdots 232 may depend on the wavelengths of the light emitted by the light source(s) 220. In one example, in which the light sources 220 are configured to emit visible light, the microdots 232 may have a diameter of approximately 0.4 mm. The diameter of the microdots 232 may also vary across the surface 212.

Referring again to FIG. 3, in one embodiment, the top surface 212 of the wave guide 210 may be at least partially covered with an angular spectrum restrictor, such as a prismatic angular control film 320, that restricts the output radiation pattern from the output illumination region of the waveguide 210 to a predetermined range of angles (in this context, the term “spectrum” is used in the sense of an angular spectrum rather than a wavelength spectrum). In one embodiment the prismatic angular control film 320 includes a brightness enhancing film (BEF) which, in addition to restricting the output spectrum, enhances the intensity of the illumination in the output illumination region. The prismatic angular control film 320 may be placed in physical contact with a diffuser 330 to collectively form a light quality enhancing apparatus. The diffuser 330 may be disposed between the prismatic angular control film 320 and the waveguide 210, as shown in FIG. 3, and in contact with the waveguide. The purpose of the diffuser 330 is to remove the effect of residual non-uniformities, such as cosmetic imperfections, in the surfaces of the waveguide 210. The diffuser 330 may be comprised of translucent material, such as a thin plastic surface or volume diffuser, both of which are characterized by very low absorption and minimum energy losses.

As discussed above, the prismatic angular control film 320 restricts output illumination within defined boundary lines and also increases the brightness within the output illumination region. In one embodiment, the prismatic angular control film 320 is a commercially available thin film having linear pyramidal structures, such as 3M model 90/24 film. The prismatic angular control film 320 transmits only those light rays from the waveguide 210 that satisfy certain incidence angle criteria with respect to the top surface 212. All other light rays are reflected back into the waveguide 210 toward the bottom or side surfaces 214 and 216, respectively, where they are reflected by the specularly reflective film 310. Thus, the reflected rays are “recycled” until they are incident on the prismatic angular control film 320 at an angle which permits them to pass through the prismatic angular control film 320.

As is well known, generally a prismatic angular control film, such as prismatic angular control film 320, concentrates illumination within boundaries defined by a pair of mutually inclined planes (which in cross-section form a “V”) and does not provide concentration in the orthogonal direction. In some applications, it may be desirable to concentrate the illumination two orthogonal directions, and for such applications, a second prismatic angular control film 325 oriented orthogonally to the first prismatic angular control film 320, may be included. With two crossed prismatic angular control films 320, 325, the light emission from the waveguide 210 will be within boundaries resembling a truncated inverted cone.

Thus, aspects and embodiments provide a microdisplay backlighting apparatus using an edge-lit waveguide and high-brightness illumination sources to provide high etendue, optionally color, illumination that is visible under full-daylight conditions. In addition, these features may be provided in a small, lightweight, and low-power package.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An edge-lit waveguide backlight apparatus comprising:
a waveguide having substantially parallel top and bottom surfaces and a side surface substantially perpendicular to the top and bottom surfaces and extending between the top and bottom surfaces along a periphery of the waveguide;
a specularly reflective film disposed on and at least partially covering the bottom surface and the side surface of the waveguide; and
at least one light source disposed on the side surface and configured to emit light into the waveguide in a direction of a length of the waveguide, the waveguide being configured to direct the light out of an output region of the top surface of the waveguide.

2. The edge-lit waveguide backlight apparatus of claim 1, wherein the waveguide comprises a solid transparent material.

3. The edge-lit waveguide backlight apparatus of claim 1, further comprising a microdot array disposed on the output region of the top surface of the waveguide.

4. The edge-lit waveguide backlight apparatus of claim 3, wherein the microdot array includes a plurality of microdots arranged in a two-dimensional array, wherein a spacing between the microdots has a linear gradient along the length of the waveguide.

5. The edge-lit waveguide backlight apparatus of claim 1, further comprising an angular spectrum restrictor disposed approximately parallel to the top surface of the waveguide and positioned to restrict output illumination through the output region to a predetermined range of angles.

6. The edge-lit waveguide backlight apparatus of claim 5, wherein the angular spectrum restrictor includes a first prismatic angular control film.

7. The edge-lit waveguide backlight apparatus of claim 6, wherein the angular spectrum restrictor further includes a second prismatic angular control film oriented orthogonally to the first prismatic angular control film.

8. The edge-lit waveguide backlight apparatus of claim 5, further comprising a diffuser disposed on the output region of the top surface of the waveguide and positioned between the top surface of the waveguide and the angular spectrum restrictor.

9. The edge-lit waveguide backlight apparatus of claim 1, wherein the specularly reflective film is further disposed on a portion of the top surface of the waveguide excluding the output region.

10. The edge-lit waveguide backlight apparatus of claim 9, wherein the specularly reflective film is a non-metallic polymer film.

11. The edge-lit waveguide backlight apparatus of claim 1, wherein the at least one light source includes at least one light emitting diode.

12. The edge-lit waveguide backlight apparatus of claim 11, wherein the at least one light emitting diode includes three light emitting diodes of different illumination colors.

13. A scene viewing apparatus comprising:
an eyepiece;
direct view optics configured to receive light from a viewed scene and focus the light along a direct view optical path to the eyepiece;
a microdisplay;
an edge-lit waveguide backlighting apparatus optically coupled to the microdisplay and configured to illuminate the microdisplay, the edge-lit waveguide backlighting apparatus including:
a waveguide having substantially parallel top and bottom surfaces and a side surface substantially perpendicular to the top and bottom surfaces and extending between the top and bottom surfaces along a periphery of the waveguide;
a specularly reflective film disposed on and at least partially covering the bottom surface and the side surface of the waveguide; and
at least one light emitting diode disposed on the side surface and configured to emit light into the waveguide in a direction of a length of the waveguide, the waveguide being configured to direct the light out of an output region of the top surface of the waveguide; and
a beamsplitter configured to couple illumination from the microdisplay into the direct view optical path to the eyepiece.

14. The scene viewing apparatus of claim 13, wherein the microdisplay is a liquid crystal display panel.

15. The scene viewing apparatus of claim 13, wherein the edge-lit waveguide backlighting apparatus further includes a microdot array disposed on the output region of the top surface of the waveguide.

16. The scene viewing apparatus of claim 13, wherein the edge-lit waveguide backlighting apparatus further includes a pair of prismatic angular control films disposed approximately parallel to the top surface of the waveguide and positioned to restrict output illumination through the output region to a predetermined range of angles, the pair of prismatic angular control films including a first film and a second film oriented orthogonally to the first film.

17. The scene viewing apparatus of claim 16, wherein the edge-lit waveguide backlighting apparatus further includes a diffuser disposed on the output region of the top surface of the waveguide and positioned between the top surface of the waveguide and the pair of prismatic angular control films.

18. The scene viewing apparatus of claim 13, wherein the specularly reflective film is further disposed on a portion of the top surface of the waveguide excluding the output region.

19. The scene viewing apparatus of claim 13, wherein the at least one light emitting diode includes three light emitting diodes of different illumination colors.

20. The scene viewing apparatus of claim 13, wherein the waveguide comprises a solid transparent material.
